(19) United States
(12) Patent Application Publication
(10) Pub. No.: US 2025/0234874 A1
(43) Pub. Date: Jul. 24, 2025

(54) PROCESSES FOR EXTRACTION, PURIFICATION, AND DRYING EXTRACTS OF POMEGRANATE

(71) Applicant: E. & J. Gallo Winery, Modesto, CA (US)

(72) Inventor: Mark A. Kelm, Fresno, CA (US)

(21) Appl. No.: 18/417,141

(22) Filed: Jan. 19, 2024

(51) Int. Cl. A23L 3/3472; A23L 27/12; B01D 15/20; B01D 15/42

(52) U.S. Cl. CPC A23B 2/733; A23L 27/12; B01D 15/203; B01D 15/424

(57) ABSTRACT

The present disclosure relates to methods for extracting pomegranate to obtain pomegranate compositions. The present disclosure is further directed to foods and beverages containing pomegranate compositions obtained by the methods.

### BACKGROUND OF THE DISCLOSURE

The present disclosure relates generally to processing biomaterials. In particular, the present disclosure is directed to methods for processing pomegranate to produce a pomegranate extract and obtaining pomegranate compositions. The present disclosure is further directed to foods and beverages containing pomegranate compositions obtained by the methods.

The pomegranate, (Punica granatum, P. protopunica) fruit includes a husk (pericarp and mesocarp), fleshy seed coat (sarcotesta) and seed. The husk and fleshy seed coat are rich sources of polyphenolics (e.g., condensed tannins, hydrolyzable tannins, phenolic acids, flavonoids). Husk also contains beta-glucans. Seed contains fatty acids. Juice is derived from pressing the fleshy seed coats and to a lesser extent, husk. Studies have shown that pomegranate juice and pomegranate extracts contain a number of bioactive compounds that are of outstanding biological significance in view of their antioxidant, antimicrobial and radical scavenging activity.

Extracts have applications in the food and beverage industry as an ingredient to modulate taste, aroma, color, tactile properties and preserve quality and increase shelf life by functioning as an antioxidant and anti-microbial. Extracts may also be used as functional ingredients in nutraceuticals or dietary supplements to benefit human and or animal health. Ingredient for cosmetics or personal care product applications may also be considered.

Patents describing recovery of polyphenolics from pomegranate have been published. Patents describe processes that extract and purify starting with plant materials (e.g., fruit, husk etc.). US 2006/0211635, for example, discloses purification of pomegranate ellagitannins from fruit husk, a by-product of the commercial juice industry. The process includes the steps of preparing an aqueous suspension from pomegranate husk, removing the suspended solids from the aqueous solution, adsorbing the ellagitannins onto a resin surface (e.g. XAD-16 resin) from the aqueous solution, eluting the resin surface with ethanol or methanol, and evaporating the solvent.

Similarly, WO 2005/097106 and the corresponding paper “Rapid large-scale purification of ellagitannins from pomegranate husk, a byproduct of the commercial juice industry” Separation and Purification Technology, ELSEVIER SCIENCE 41, n. 1, January 2005, pages 49-55 describe the extraction of punicalagins from the husk only. Tannins adsorbed on an adsorption resin vacuum-aspirated column are recovered by elution with methanol. U.S. Pat. No. 9,839,659B2 describes pomegranate extract containing large amount of ellagic acid and use of the pomegranate extract for treating women's menopausal symptoms. EP1967079B1 describes a process for preparing pomegranate extracts for the production of pomegranate ellagitannins-containing products to be used as a source of ellagitannins in food, medical and cosmetic industries. FR2874502A1 describes the preparation of pomegranate extract to amplify the expression of aquaporins in the treatment of skin. The process repeatedly extracts the fruit pulp with a polar solvent, filtering and concentrating to produce a final extract more concentrated in aquaporins. Other methods purify condensed tannin extracts utilizing selective organic solvents and high-performance liquid chromatography.

Many processes for extracting plant materials are time consuming and involve expensive equipment and/or toxic solvents. Accordingly, there exists a need for alternative cost-effective methods for extracting and purifying components from plant materials that do not use toxic and environmentally unfriendly chemicals. The methods of the present disclosure provide a pomegranate extract including polyphenols, sugars, acids, and combinations thereof. The extracts obtained by the methods of the present disclosure can be used in the food and beverage industries for modulating taste, aroma, color, and tactile properties. The extracts can also be used as functional ingredients in nutraceuticals and dietary supplements and in cosmetics and personal care products.

### BRIEF DESCRIPTION OF THE DISCLOSURE

The present disclosure relates to preparing a pomegranate composition from a pomegranate extract. The method includes contacting pomegranate with water to create a pomegranate-water slurry; treating the pomegranate-water slurry with pectolytic enzymes; adjusting pH of the pomegranate-water slurry to a range of about 1.5 to about 2.5; clarifying the liquid to produce an aqueous phase and a precipitate; separating the aqueous phase to produce a permeate and a retentate; and recovering the pomegranate composition from at least one of the retentate, the permeate, and combinations thereof, wherein the pomegranate composition is selected from the group consisting of at least one of a phenolic acid, a flavanol, an ellagitannin, a hygroscopic sugar, an organic acid, a mineral, and combinations thereof.

In another aspect, the present disclosure is directed to a method of a pomegranate composition from a pomegranate extract. The method includes: contacting pomegranate with water to create a pomegranate-water slurry; heating the pomegranate-water slurry at a temperature ranging from about 80° C. to about 120° C.; treating the pomegranate-water slurry with pectolytic enzymes; separating the pomegranate-water slurry to produce a liquid phase and a solid phase; adjusting pH of the liquid phase to a range of about 1.5 to about 2.5; incubating the liquid phase at a temperature ranging from about 4° C. to about 15° C.; clarifying the liquid phase to produce an aqueous phase and a precipitate; contacting the aqueous phase with a chromatographic resin; washing the chromatographic resin to produce a wash eluate; eluting the chromatographic resin to desorb an eluate; and recovering the pomegranate composition from at least one of the eluate, the wash eluate, and combinations thereof, wherein the pomegranate composition is selected from the group consisting of at least one of a phenolic acid, a flavanol, an ellagitannin, a hygroscopic sugar, an organic acid, a mineral, and combinations thereof.

### BRIEF DESCRIPTION OF THE DRAWINGS

The disclosure will be better understood, and features, aspects, and advantages other than those set forth above will become apparent when consideration is given to the following detailed description thereof. Such detailed description makes reference to the following drawings, wherein:

FIG. 1 is a flow diagram depicting a method for preparing pomegranate polyphenols according to an exemplary embodiment of the present disclosure.

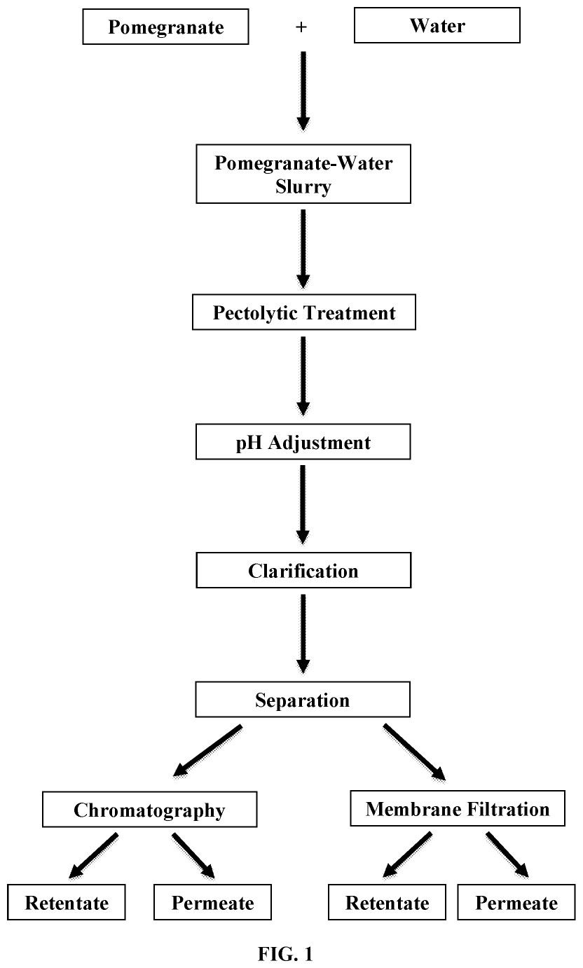

FIG. 2 is a chromatogram of pomegranate extract 1.

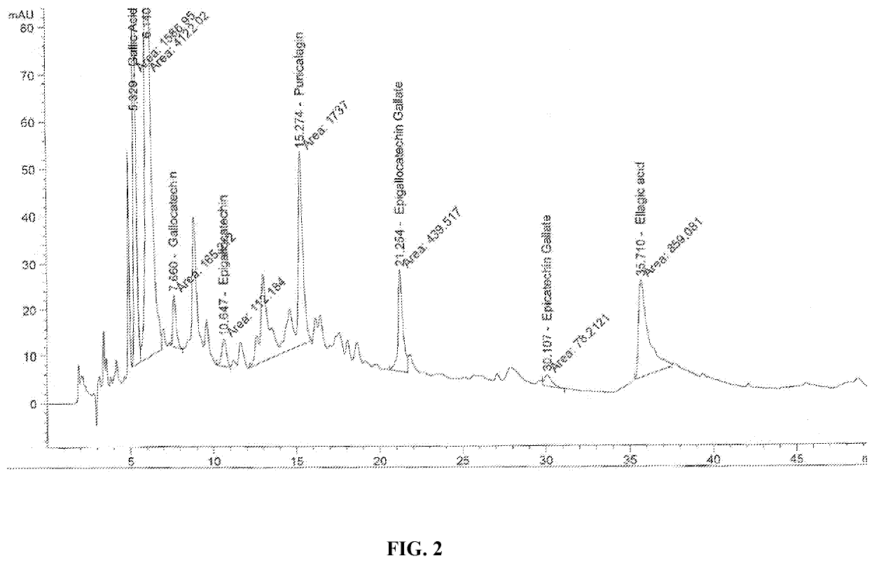

FIG. 3 is a chromatogram of pomegranate extract 2.

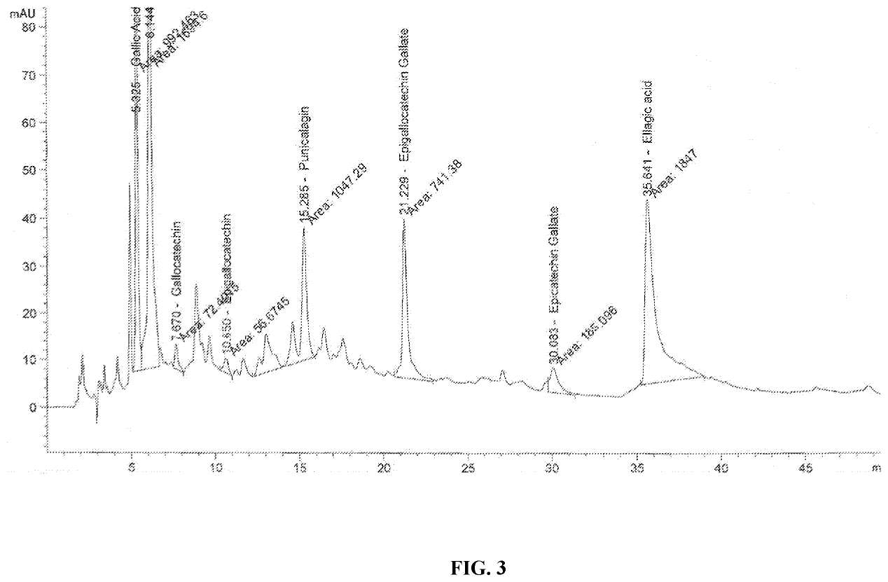

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

The present disclosure is directed to methods for extracting pomegranate to obtain a pomegranate composition. The method is particularly suitable for obtaining pomegranate compositions including phenolic acids, flavanols, ellagitannins, hygroscopic sugars, organic acids, minerals, and combinations thereof.

In one aspect, the present disclosure is directed to a method of preparing a pomegranate composition from a pomegranate extract. The method includes contacting pomegranate with water to create a pomegranate-water slurry; treating the pomegranate-water slurry with pectolytic enzymes; adjusting pH of the pomegranate-water slurry to a range of about 1.5 to about 2.5; clarifying the liquid to produce an aqueous phase and a precipitate; separating the aqueous phase to produce a permeate and a retentate; and recovering the pomegranate composition from at least one of the retentate, the permeate, and combinations thereof, wherein the pomegranate composition is selected from the group consisting of at least one of a phenolic acid, a flavanol, an ellagitannin, a hygroscopic sugar, an organic acid, a mineral, and combinations thereof.

The method includes obtaining the phenolic acid, the flavanol, the ellagitanin, and combinations thereof, from the retentate. Phenolic acids obtained from the retentate include gallic acid, ellagic acid, and combinations thereof. Flavanols obtained from the retentate include catechin, epicatechin, gallocatechin, epigallocatechin, epigallocatechin gallate, and combinations thereof. Ellagitanins obtained from the retentate include punicalagins.

The method includes obtaining hydrogoscopic sugars, organic acids, minerals, and combinations thereof, from the permeate. Hygroscopic sugars obtained from the permeate include glucose, fructose, and combinations thereof. Organic acids obtained from the permeate include citric acid, malic acid, oxalic, acid, tartaric acids, and combinations thereof. Minerals obtained from the permeate include calcium, iron, potassium, magnesium, phosphorus, sodium, zinc, copper, manganese, selenium, and combinations thereof.

The step of contacting the pomegranate with water to create a pomegranate-water slurry suitably occurs at temperature ranging from an ambient temperature to about 120° C., including from about 20° C. to about 110° C., preferably from about 70° C. to about 100° C., more preferably about 80° C. to about 100° C., and most preferably from about 90° C. to about 100° C., by continuous heating. Suitably, the pomegranate-water slurry is contacted for a specific time interval, wherein the time interval can vary from about 0.5 hour to about 5 hours, including from about 1 hour to about 3 hours, and more preferably for about 2 hours. In a particularly preferred embodiment, the step of contacting the pomegranate with water to create a pomegranate-water slurry is boiled at a temperature of about 100° C. for a time interval of about 2 hours.

The method can further include homogenizing the pomegranate-water slurry. Homogenizing methods are known in the art and include blenderizing, dounce homogenizing, pressure homogenizing, sonication, and the like.

Suitably, treating the pomegranate-water slurry with pectolytic enzymes is carried out for a specific time interval, wherein the time interval can vary from about 12 hours to about 48 hours, including from about 12 hours to about 24 hours, and preferably for about 24 hours. In one embodiment, the pectolytic enzymes are added to the pomegranate-water slurry. In another embodiment, the pomegranate-water slurry is separated by, for example, centrifugation, filtration, and combinations thereof, to produce a solid material and a liquid material, and pectolytic enzymes are added to the liquid material.

In some embodiments, the method includes heating the pomegranate-water slurry to a temperature ranging from about 80° C. to about 120° C. A particularly suitable temperature is about 100° C. Suitably, the pomegranate-water slurry is heated at range of about 80° C. to about 120° C. for a time interval ranging from about 0.5 hour to about 3 hours, including from about 1 hour to about 2 hours, preferably about 2 hours. Suitably, the pomegranate-water slurry is heated at about 100° C. to about 120° C. for a time interval ranging from about 0.5 hour to about 3 hours, including from about 1 hour to about 2 hours, preferably about 2 hours.

Suitable pectolytic enzymes include pectinase. Pectinase can be obtained from commercial sources (e.g., PECTINEX® Ultra SP-L from Novozyme, Salem, VA, USA Carolina Biological Supply, Burlington, NC, USA; Thomas Scientific, Swedesboro, NJ, USA). The amount of pectolytic enzymes used to treat the pomegranate-water slurry ranges from about 100 parts per million (ppm) to about 300 ppm. Preferably, the amount of pectolytic enzymes is about 200 ppm.

The step of adjusting pH of the pomegranate-water slurry includes adjusting the pH of the pomegranate-water slurry to a range of about 1.5 to about 2.5, including to a range of about 1.8 to about 2.2, including from about 2.0 to about 2.15 to precipitate fine solids from the liquid reduces the pH to about 2.0. Suitably, following adjusting the pH of the pomegranate-water slurry to a range of about 1.5 to about 2.5, the method includes reducing the temperature of the pomegranate-water slurry to a range of from greater than 0° C. to 15° C., including from about 4° C. to about 10° C. Suitably, the pomegranate-water slurry is incubated at the reduced temperature for a specific time interval, wherein the time interval can vary from about 12 hours to about 48 hours, including from about 12 hours to 24 hours. Without being bound by theory, adjusting the pH to a range of about 1.5 to about 2.5 results in precipitation of fine solids.

The method further includes clarifying the pomegranate-water slurry to produce an aqueous phase and a precipitate. The clarifying step is done by centrifugation, membrane filtration, and combinations thereof.

In one embodiment, the separating step is performed by loading the aqueous phase onto a chromatographic resin. Suitable chromatographic resins are known in the art and include XAD7-HP resin (commercially available from DUPONT, Hayward, CA). XAD7-HP is a crosslinked aliphatic acrylic adsorbent resin with water retention capacity of 61-69%, average surface area of 750 m²/g, and a mean pore size of ˜550 Å. Other suitable chromatographic resins include any nonionic weakly polar, hydrophobic aliphatic acrylic ester polymers (e.g., XAD7, XAD 7HP), crosslinked polymethacrylate polymers (e.g., Mitsubishi HP2MGL), mixed mode (e.g., Dow Optipore LA93), polyaromatic styrene, and (ethylene) divinyl benzene polymers (e.g., Dow XAD-2, XAD-4, XAD 18, XAD 1600N, FPX-66 and Mitsubishi SP700, SP850, SP825). After loading, the chromatographic column is washed with water (0.5 to 2 L). Organic acids, hygroscopic sugars, and minerals may be recovered from the water eluate. Polyphenolics (phenolic acids), flavanols, ellagitanins, and related chemistries are desorbed from the chromatographic resin with 75% ethanol in water. In addition to ethanol, other suitable water miscible solvents such as, methanol, isopropanol, propanol, acetone individually or as mixtures can be used. A step or linear gradient of water miscible solvent into water may be employed to yield various compositionally different fractions. Ethanol (or other solvent) is removed by rotary evaporation under reduced pressure. The fractions can then be finally dried using refractance window drying technique.

In another embodiment, the separating step is performed by membrane filtration, wherein the aqueous phase is placed in a membrane filter having a molecular weight cutoff ranging from about 1000 Daltons (Da) to about 10000 Da. Suitably, diafiltration with water is conducted to collect hygroscopic sugars, organic acids, and minerals from the permeate. Suitable membrane filters are commercially available (e.g., Snyder filtration membranes, Vacaville, CA, USA).

In another embodiment, the method further includes drying the retentate to produce a dried solid. Ethanol (and other water miscible solvents) is removed from the retentate by rotary evaporation under reduced pressure and finally dried using refractance window drying technique. The dried solid is produced as a brown glassy solid that includes polyphenolics. The resultant polyphenols include gallic acid, catechin, epicatechin, and combinations thereof. The drying step also concentrates the pomegranate composition obtained from the retentate.

In another aspect, the present disclosure is directed to a food or a beverage containing the pomegranate composition obtained by the method. In particular, the food and/or beverage includes any one of the phenolic acids, the flavanols, the ellagitannins, the hygroscopic sugars, the organic acids, the minerals, and combinations thereof, obtained by the method. The food and/or beverages include any one of gallic acid, ellagic acid, catechin, epicatechin, gallocatechin, epigallocatechin, epigallocatechin gallate, ellagitanin, glucose, fructose, citric acid, malic acid, oxalic, acid, tartaric acid, calcium, iron, potassium, magnesium, phosphorus, sodium, zinc, copper, manganese, selenium, and combinations thereof, obtained by the method.

Suitable pomegranate (Punica granatum) used in the methods of the present disclosure includes pomegranate husk, pomegranate fruit, pomegranate seeds, pomegranate juice, pomegranate leaves, pomegranate woody stems, pomegranate pomace, and combinations thereof. The pomegranate starting material used to make the pomegranate-water slurry can be dried and/or wet. If dried pomegranate is used as the starting material, the dried pomegranate can be rehydrated by soaking in water, for example, prior to creating the pomegranate-water slurry.

In another aspect, the present disclosure is directed to a method of preparing a pomegranate composition from a pomegranate extract. The method includes contacting pomegranate with water to create a pomegranate-water slurry; at a temperature ranging from about 80° C. to about 120° C.; treating the pomegranate-water slurry with pectolytic enzymes; separating the pomegranate-water slurry to produce a liquid phase and a solid phase; adjusting pH of the liquid phase to a range of about 1.5 to about 2.5; incubating the liquid phase at a temperature ranging from about 4° C. to about 15° C.; clarifying the liquid phase to produce an aqueous phase and a precipitate; contacting the aqueous phase with a chromatographic resin; washing the chromatographic resin to produce a wash eluate; eluting the chromatographic resin to desorb an eluate; and recovering the pomegranate composition from at least one of the eluate, the wash eluate, and combinations thereof, wherein the pomegranate composition is selected from the group consisting of at least one of a phenolic acid, a flavanol, an ellagitannin, a hygroscopic sugar, an organic acid, a mineral, and combinations thereof.

The method includes obtaining the phenolic acid, the flavanol, the ellagitanin, and combinations thereof, from the eluate. Phenolic acids obtained from the eluate include gallic acid, ellagic acid, and combinations thereof. Flavanols obtained from the eluate include catechin, epicatechin, gallocatechin, epigallocatechin, epigallocatechin gallate, and combinations thereof. Ellagitanins obtained from the eluate include punicalagins.

The method includes obtaining hydrogoscopic sugars, organic acids, minerals, and combinations thereof, from the wash eluate. Hygroscopic sugars obtained from the wash eluate include glucose, fructose, and combinations thereof. Organic acids obtained from the wash eluate include citric acid, malic acid, oxalic, acid, tartaric acid, and combinations thereof. Minerals obtained from the wash eluate include calcium, iron, potassium, magnesium, phosphorus, sodium, zinc, copper, manganese, selenium, and combinations thereof.

In some embodiments, the method includes heating the pomegranate-water slurry to a temperature ranging from about 80° C. to about 120° C. A particularly suitable temperature is about 100° C. Suitably, the pomegranate-water slurry is heated at range of about 80° C. to about 120° C. for a time interval ranging from about 0.5 hour to about 3 hours, including from about 1 hour to about 2 hours, preferably about 2 hours. Suitably, the pomegranate-water slurry is heated at about 100° C. to about 120° C. for a time interval ranging from about 0.5 hour to about 3 hours, including from about 1 hour to about 2 hours, preferably about 2 hours.

Suitable chromatographic resin includes XAD7-HP resin (commercially available from DUPONT, Hayward, CA). XAD7-HP is a crosslinked aliphatic acrylic adsorbent resin with water retention capacity of 61-69%, average surface area of 750 m²/g, and a mean pore size of ˜550 Å. XAD7-HP resin (commercially available from DUPONT, Hayward, CA). XAD7-HP is a crosslinked aliphatic acrylic adsorbent resin with water retention capacity of 61-69%, average surface area of 750 m²/g, and a mean pore size of ˜550 Å. Other suitable chromatographic resins include any nonionic weakly polar, hydrophobic aliphatic acrylic ester polymers (e.g., XAD7, XAD 7HP), crosslinked polymethacrylate polymers (e.g., Mitsubishi HP2MGL), mixed mode (e.g., Dow Optipore L493), polyaromatic styrene, and (ethylene) divinyl benzene polymers (e.g., Dow XAD-2, XAD-4, XAD 18, XAD 1600N, FPX-66 and Mitsubishi SP700, SP850, SP825). After loading, the chromatographic column is washed with water (0.5 to 2 L). Organic acids and sugars may be recovered from the water eluate. Polyphenolics, flavanols, ellagitanins, and related chemistries are desorbed from the chromatographic resin with 75% ethanol in water. In addition to ethanol, other suitable water miscible solvents such as, methanol, isopropanol, propanol, acetone individually or as mixtures can be used. A step or linear gradient of water miscible solvent into water may be employed to yield various compositionally different fractions.

Suitably, treating the pomegranate-water slurry with pectolytic enzymes is carried out for a specific time interval, wherein the time interval can vary from about 12 hours to about 48 hours, including from about 12 hours to about 24 hours, and preferably for about 24 hours.

Suitably, the pomegranate-water slurry is incubated at the reduced temperature for a specific time interval, wherein the time interval can vary from about 12 hours to about 48 hours, including from about 12 hours to 24 hours. Without being bound by theory, adjusting the pH to a range of about 1.5 to about 2.5 results in precipitation of fine solids.

Suitably, clarifying the liquid phase to produce an aqueous phase and precipitate can be done by centrifugation, filtration, and combinations thereof.

In another embodiment, the method further includes drying the eluate to produce a dried solid. Ethanol (and other water miscible solvents) is removed from the eluate by rotary evaporation under reduced pressure and finally dried using refractance window drying technique. The dried solid is produced as a brown glassy solid that includes polyphenolics. The resultant polyphenols include gallic acid, catechin, epicatechin, and combinations thereof. The drying step also concentrates the pomegranate composition obtained from the eluate.

Suitable pomegranate (Punica granatum) used in the methods of the present disclosure includes pomegranate husk, pomegranate fruit, pomegranate seeds, pomegranate juice, pomegranate leaves, pomegranate woody stems, pomegranate pomace, and combinations thereof. The pomegranate starting material used to make the pomegranate-water slurry can be dried and/or wet. If dried pomegranate is used as the starting material, the dried pomegranate can be rehydrated by soaking in water, for example, prior to creating the pomegranate-water slurry.

In another aspect, the present disclosure is directed to a food or a beverage containing the pomegranate composition obtained by the method. In particular, the food and/or beverage includes any one of the phenolic acids, the flavanols, the ellagitannins, the hygroscopic sugars, the organic acids, the minerals, and combinations thereof, obtained by the method. The food and/or beverages include any one of gallic acid, ellagic acid, catechin, epicatechin, gallocatechin, epigallocatechin, epigallocatechin gallate, ellagitanin, glucose, fructose, citric acid, malic acid, oxalic, acid, tartaric acid, calcium, iron, potassium, magnesium, phosphorus, sodium, zinc, copper, manganese, selenium, and combinations thereof, obtained by the method.

### EXAMPLES

### Example 1

In this Example, pomegranate husks were dried in an oven at 180° F. (0.32% Moisture Content (MC)). 100.04 grams of dried husks were contacted with 500 mL of DI water to make a pomegranate-water slurry and boiled for 2 hours. Pectinase (200 ppm) was added to the pomegranate-water slurry and treated for 24 hours. After 24 hours, the pH of the pomegranate-water slurry was reduced to 2.01 and chilled for 24 hours. After 24 hours, the pomegranate-water slurry was centrifuged and filtered (#1 Whatman) to produce an extract volume of about 385 mL. The aqueous phase was loaded onto an XAD7-HP resin, washed with 1.2 L of DI water to wash out a yellow eluate, which was collected. The XAD7-HP resin was eluted with 100 mL of 150 proof ethanol. Ethanol was removed by rotary evaporation under reduced pressure and finally dried using refractance window drying technique to obtain a brown glassy solid (˜5.09 g). Total phenols on dry basis was 77.33%. The percent gallic acid by weight measured 1.50%. The percent catechin by weight measured 0.28%. The percent epicatechin by weight measured 0.17%.

### Example 2

In this Example, pomegranate husks were dried in an oven at 180° F. (0.32% MC). 100.03 grams of dried husks were contacted with 500 mL of DI water to make a pomegranate-water slurry and boiled for 2 hours. The pomegranate-water slurry was centrifuged to remove solid materials and pectinase (200 ppm) was added to the liquid fraction and treated for 24 hours. After 24 hours, the pH of the liquid fraction was reduced to 2.13 and chilled for 24 hours. After 24 hours, the liquid fraction was centrifuged and filtered (#1 Whatman) to produce an extract volume of about 365 mL. The aqueous phase was loaded onto an XAD7-HP resin, washed with 1.2 L of DI water to wash out a yellow eluate, which was collected. The XAD7-HP resin was eluted with 100 mL of 150 proof ethanol. Ethanol was removed by rotary evaporation under reduced pressure and finally dried using refractance window drying technique to obtain a brown glassy solid (˜5.33 g). Total phenols on dry basis was 79.20%. The percent gallic acid by weight measured 1.12%. The percent catechin by weight measured 0.31%. The percent epicatechin by weight measured 0.11%.

### Example 3

In this Example, frozen pomegranate husks were defrosted (65.84% MC) and 100.26 grams of thawed husks were contacted with 500 mL of DI water to make a pomegranate-water slurry and boiled for 2 hours. Pectinase (200 ppm) was added to the pomegranate-water slurry and treated for 24 hours. After 24 hours, the pH of the pomegranate-water slurry was reduced to 2.03 and chilled for 5 days. After 5 days, the pomegranate-water slurry was centrifuged and filtered (#1 Whatman) to produce an extract volume of about 520 mL. The aqueous phase was loaded onto an XAD7-HP resin, washed with 300 mL of DI water to wash out a yellow eluate, which was collected. The XAD7-HP resin was eluted with 100 mL of 150 proof ethanol. Ethanol was removed by rotary evaporation under reduced pressure and finally dried using refractance window drying technique to obtain a brown glassy solid (˜3.02 g). Total phenols on dry basis was 74.18%. The percent gallic acid by weight measured 1.53%. The percent catechin by weight measured 0.24%. The percent epicatechin by weight measured 0.11%.

### Example 4

In this Example, frozen pomegranate husks were defrosted (65.84% MC) and 100.27 grams of thawed husks were contacted with 500 mL of DI water to make a pomegranate-water slurry and boiled for 2 hours. The pomegranate-water slurry was centrifuged to remove solid materials and pectinase (200 ppm) was added to the liquid fraction and treated for 24 hours. After 24 hours, the pH of the liquid fraction was reduced to 2.16 and chilled for 5 days. After 5 days, the liquid fraction was centrifuged and filtered (#1 Whatman) to produce an extract volume of about 519 mL. The aqueous phase was loaded onto an XAD7-HP resin, washed with 300 mL of DI water to wash out a yellow eluate, which was collected. The XAD7-HP resin was eluted with 100 mL of 150 proof ethanol. Ethanol was removed by rotary evaporation under reduced pressure and finally dried using refractance window drying technique to obtain a brown glassy solid (˜3.56 g). Total phenols on dry basis was 78.04%. The percent gallic acid by weight measured 1.54%. The percent catechin by weight measured 0.28%. The percent epicatechin by weight measured 0.10%.

As disclosed herein, the present disclosure provides new methods of extracting pomegranate to obtain ingredients useful in the food and beverage industry to modulate taste, aroma, color, tactile properties and preserve quality and increase shelf life by functioning as an antioxidant and anti-microbial. The ingredients can also be used as functional ingredients in nutraceuticals and dietary supplements to benefit human and animal health. The ingredients can further be used in cosmetics and personal care products. Advantageously, the methods of the present disclosure employ greener and more cost-effective technologies that do not involve toxic solvents or less efficient processes. The methods of the present disclosure can also be used to produce value added products using pomegranate waste created in other pomegranate processing methods.

What is claimed is:

1. A method of preparing a pomegranate composition from a pomegranate extract, the method comprising:
contacting pomegranate with water to create a pomegranate-water slurry;
treating the pomegranate-water slurry with pectolytic enzymes;
adjusting pH of the pomegranate-water slurry to a range of about 1.5 to about 2.5;
clarifying the pomegranate-water slurry to produce an aqueous phase and a precipitate;
separating the aqueous phase to produce a permeate and a retentate; and
recovering the pomegranate composition from at least one of the retentate, the permeate, and combinations thereof, wherein the pomegranate composition is selected from the group consisting of at least one of a phenolic acid, a flavanol, an ellagitannin, a hygroscopic sugar, an organic acid, a mineral, and combinations thereof.

2. The method of claim 1, wherein the retentate comprises the phenolic acid, the flavanol, the ellagitanin, and combinations thereof.

3. The method of claim 1, wherein the permeate comprises the hygroscopic sugar, the organic acid, the mineral, and combinations thereof.

4. The method of claim 1, wherein the pomegranate is selected from pomegranate husk, pomegranate fruit, pomegranate seeds, pomegranate juice, pomegranate leaves, pomegranate woody stems, pomegranate pomace, and combinations thereof.

5. The method of claim 1, wherein the clarifying step is selected from filtration, centrifugation, and combinations thereof.

6. The method of claim 1, wherein the separating step is selected from chromatography, ultrafiltration membrane separation, and combinations thereof.

7. The method of claim 1, further comprising heating the pomegranate-water slurry to a temperature ranging from about 80° C. to about 120° C.

8. The method of claim 1, further comprising homogenizing the pomegranate-water slurry.

9. A food comprising the pomegranate composition obtained by the method of claim 1.

10. A beverage comprising the pomegranate composition obtained by the method of claim 1.

11. A method of preparing a pomegranate composition from a pomegranate extract, the method comprising:
contacting pomegranate with water to create a pomegranate-water slurry;
heating the pomegranate-water slurry at a temperature ranging from about 80° C. to about 120° C.;
treating the pomegranate-water slurry with pectolytic enzymes;
separating the pomegranate-water slurry to produce a liquid phase and a solid phase;
adjusting pH of the liquid phase to a range of about 1.5 to about 2.5;
incubating the liquid phase at a temperature ranging from about 4° C. to about 15° C.;
clarifying the liquid phase to produce an aqueous phase and a precipitate;
contacting the aqueous phase with a chromatographic resin;
washing the chromatographic resin to produce a wash eluate;
eluting the chromatographic resin to desorb an eluate; and
recovering the pomegranate composition from at least one of the eluate, the wash eluate, and combinations thereof, wherein the pomegranate composition is selected from the group consisting of at least one of a phenolic acid, a flavanol, an ellagitannin, a hygroscopic sugar, an organic acid, a mineral, and combinations thereof.

12. The method of claim 11, wherein the eluate comprises the phenolic acid, the flavanol, the ellagitanin, and combinations thereof.

13. The method of claim 11, wherein the wash eluate comprises the hygroscopic sugar, the organic acid, the mineral, and combinations thereof.

14. The method of claim 11, wherein the clarifying step is selected from filtration, centrifugation, and combinations thereof.

15. The method of claim 11, wherein the separating step is selected from chromatography, ultrafiltration membrane separation, and combinations thereof.

16. The method of claim 11, wherein the pomegranate is selected from pomegranate husk, pomegranate fruit, pomegranate seeds, pomegranate juice, pomegranate leaves, pomegranate woody stems, pomegranate pomace, and combinations thereof.

17. The method of claim 11, further comprising homogenizing the pomegranate-water slurry.

18. The method of claim 11, further comprising drying the eluate to produce a brown-glassy solid.

19. A food comprising pomegranate composition obtained by the method of claim 11.

20. A beverage comprising pomegranate composition obtained by the method of claim 11.
